(19) United States
(12) Patent Application Publication
(10) Pub. No.: US 2011/0080689 A1
(43) Pub. Date: Apr. 7, 2011

(54) Ionic Liquids for Use in Ultracapacitor and Graphene-Based Ultracapacitor

(76) Inventors: Christopher W. Bielawski, Austin, TX (US); Rodney S. Ruoff, Austin, TX (US); Dileep K. Agnihotri, Round Rock, TX (US); Daniel R. Dreyer, Austin, TX (US); Meryl D. Stoller, Austin, TX (US); Yanwu Zhu, Austin, TX (US)

(21) Appl. No.: 12/875,880

(22) Filed: Sep. 3, 2010

Related U.S. Application Data
(60) Provisional application No. 61/240,120, filed on Sep. 4, 2009.

(51) Int. Cl. H01G 9/155; C01B 31/00

(52) U.S. Cl. 361/502; 423/415.1

(57) ABSTRACT

One embodiment of the current disclosure provides an ultracapacitor including at least one graphene-based electrode, an electrolyte containing an ionic liquid, and a dielectric separator dividing the ultracapacitor into two chambers, each chamber containing an electrode and a portion of the electrolyte. In another embodiment, the graphene has been expanded by exposure to microwave radiation then chemically activated. Another embodiment of the current disclosure provides an electrochemical energy storage device containing such an ultracapacitor. Still other embodiments of the disclosure relate to ionic liquids, some of which may be suitable for use in an ultracapacitor, methods of synthesizing such liquids, and methods of designing such liquids. Further embodiments relate to methods of using ultracapacitors, for example in automobiles, power grids, high-temperature applications, and other applications.

### PRIORITY CLAIM

The current application claims priority under 35 U.S.C. §119 to U.S. Provisional Patent Application Ser. No. 61/240,120 filed Sep. 4, 2009 and titled IONIC LIQUIDS AND GRAPHENE-BASED ULTRACAPACITORS, incorporated by reference herein.

### STATEMENT OF GOVERNMENT INTEREST

At least portions of this invention were made using U.S. government funding provided by the National Science Foundation under grant number DMR-0907324 and by the Department of Energy under grant number ER46657. The U.S. government has certain rights in the invention.

### TECHNICAL FIELD

The current disclosure relates to ultracapacitors. One embodiment relates to ionic liquids for use in ultracapacitors and methods of making and using such liquids and ultracapacitors. Another embodiment relates to graphene-based ultracapacitors and methods of making and using such ultracapacitors. Yet another embodiment relates to the design and synthesis of an ionic liquid.

### BACKGROUND

In order to provide power to electrical devices, electrical energy must either be provided essentially continuously, for example from a wall outlet, or it must be stored so that it can be provided at a later time on demand. One common method of storing electrical energy is via batteries. Batteries undergo a chemical reaction when they are accumulating electrical energy for storage. A reverse chemical reaction occurs when the battery is used and that energy is released. Although batteries are able to achieve a high energy density (e.g. a large amount of energy per weight of battery), they have a limited lifespan even if they are rechargeable because the chemical reactions cause chemical breakdown and eventually the battery can no longer be charged. Chemical reactions also can only happen at relatively slow speeds compared to movement of electricity, so electrical energy cannot be released from a battery quickly enough for some uses. Further, batteries generally have poor power density, i.e. they cannot release energy very quickly per weight of battery.

Ultracapacitors (also referred to as supercapacitors) incorporate chemicals into their composition and structure, but they do not rely on chemical reactions. Instead, ultracapacitors store electrical energy electrostatically, i.e. the energy is stored by electrically charged chemicals called ions, that are in a liquid called the electrolyte. As electrical energy is added to a capacitor, these ions move around inside the capacitor to positions relative to an electrically conductive solid component, called an electrode and this repositioning of the ions enhances the storage of electrical charge in the electrodes. When the electrical charge in the electrodes is released through an external circuit as electrical current, the ions relax to a different configuration. Thus, ultracapacitors rely primarily on movement of ions to store electrical energy. This allows such ultracapacitors to be charged very rapidly and to release stored electrical energy very rapidly. Although some ultracapacitor systems may include chemical-reaction based features, such as pseudocapacitance, which can involve proton transfer or other chemical processes, these reactions tend to have a slow reaction time.

Ultracapacitors are known for having high power density. However, one drawback of currently existing ultracapacitors is in their energy density at full charge. Current ultracapacitors have about one fifth the energy density of a lead acid battery, which tends to make them costly and inconvenient to use in applications calling for high energy density. Furthermore, current ultracapacitors are not able to operate at high temperatures, such as temperatures above 65° C., due to the requirement for the electrolyte to be dissolved in a solvent, which is susceptible to vaporization and decomposition, limiting their usefulness in many applications. In addition, current ultracapacitors tend to suffer degradation due to residual water.

Some ultracapacitors have attempted to overcome one or a few of these problems by using an ionic liquid as the electrolyte. Some such ultracapacitors have also tried using physically or thermally activated graphenes as electrodes. Methods which are typically broadly classified as ‘physical’ or ‘thermal’ methods for activation include the use of steam or CO₂, and extensive study of these two activation agents has been carried out. The resulting carbon materials from these two processes differ in terms of porosity and surface area from carbon materials that are activated by other methods. Ultracapacitors using ionic liquids and physically or thermally activated carbon materials have yet to obtain high performance characteristics, such as high specific capacitance or high energy or power density.

Accordingly, a need exists for new ultracapacitors that achieve many of the benefits of current ultracapacitors, such as high power density, but that also have an acceptable or high level of energy density. There is also a need for ultracapacitors able to function at higher temperatures than current ultracapacitors. Finally, there is a need for ultracapacitors with less or no degradation due to residual water.

### SUMMARY

Accordingly, one embodiment of the current disclosure provides an ultracapacitor including at least one graphene-based electrode, an electrolyte containing an ionic liquid, and a dielectric separator dividing the ultracapacitor into two chambers, each chamber containing an electrode and a portion of the electrolyte.

According to a specific embodiment, the graphene may be a chemically modified graphene. For example, it may be a chemically activated microwave expanded graphite oxide (MEGO). The graphene may have been chemically activated and further reduced using a reagent selected from the group consisting of: sodium hydroxide, zinc chloride, aluminium chloride, magnesium chloride, boric acid, nitric acid, phosphoric acid, potassium hydroxide, and combinations thereof.

According to another specific embodiment, the ionic liquid is selected from the group consisting of: a pyrrolidinium-based ionic liquid having a melting point lower than −10° C., a non-pyrrolidinium-based cyclic ammonium, a phosphonium-based cyclic ammonium, a spirocyclic ammonium- or phosphonium -based ionic liquid, an acyclic ammonium- or phosphonium-based ionic liquid, and any combinations thereof.

Another embodiment of the current disclosure provides an electrochemical energy storage device containing such an ultracapacitor as described above.

Still other embodiments of the disclosure relate to ionic liquids, some of which may be suitable for use in an ultracapacitor, methods of synthesizing such liquids, and methods of designing such liquids.

Further embodiments relate to methods of using ultracapacitors, for example in automobiles, power grids, high-temperature applications, and other applications.

The disclosure also includes a process of making activated microwave expanded graphite oxide (MEGO) by expanding and reducing graphite oxide with microwave radiation to produce MEGO; and chemically activating the MEGO using a reagent selected from the group consisting of: sodium hydroxide, potassium hydroxide, steam, carbon dioxide, zinc chloride, aluminum chloride, magnesium chloride, boric acid, nitric acid, phosphoric acid, and any combinations thereof to produce a chemically activated and further reduced MEGO.

### BRIEF DESCRIPTION OF THE DRAWINGS

A more complete and thorough understanding of the present embodiments and advantages thereof may be acquired by referring to the following description taken in conjunction with the accompanying drawings wherein:

FIG. 1 illustrates an ultracapacitor according to an embodiment of the current disclosure.

FIG. 2 illustrates scanning electron micrographs and schematic depictions of graphene according to embodiments of the current disclosure.

FIG. 3 illustrates ionic liquids according to embodiments of the current disclosure as well as N-methyl-N-alkyl pyrrolidinium bistriflimide according to the prior art, used as a comparative example.

FIG. 4 illustrates additional ionic liquids according to embodiments of the current disclosure.

FIG. 5 illustrates the energy density for various electrode and electrolyte combinations. On the energy density scale, 1 equals 5 Wh/kg.

FIG. 6 illustrates a cyclic voltammogram showing N-methyl-N-octylpyrrolidinium triflate ionic liquid in acetonitrile (1:1 w/w) electrolyte performance in an activated carbon electrode (using Westvaco activated carbon) ultracapacitor. The scan rate was 100 mV/sec.

FIG. 7 illustrates a cyclic voltammogram showing N-methyl-N-octylpyrrolidinium triflate ionic liquid in acetonitrile (1:1 w/w) electrolyte performance in a graphene material electrode ultracapacitor. The scan rate was 20 mV/sec.

FIG. 8 illustrates a cyclic voltammogram showing 1-butyl-3-methylimidazolium tetrafluoroborate (BMIM BF₄) ionic liquid in acetonitrile (1:1 w/w) with an activated microwave expanded graphite oxide (MEGO) based graphene electrode. The scan rate was 100 mV/sec.

FIG. 9 illustrates a Nyquist plot showing BMIM BF4 ionic liquid in acetonitrile (1:1 w/w) with an activated MEGO electrode. The calculated resistive-capacitive (RC) time constant is 0.5 seconds.

FIG. 10 illustrates a constant current charge discharge plot showing BMIM BF4 ionic liquid in acetonitrile (1:1 w/w) with an activated MEGO electrode. The discharge current was 10 mA (2830 mA/g current density) and the specific capacitance during discharge from Vmax to ½ Vmax (3.5V to 1.75V) was 166 F/g.

### DETAILED DESCRIPTION

The current disclosure relates to ionic liquids and ultracapacitors using ionic liquids. It also relates to ultracapacitors using graphene. According to the embodiment shown in FIG. 1, the ultracapacitor 10 may have two electrodes 20, an electrolyte 30, and a non-conductive or dielectric separator 40. A potential, ΔV, may be applied and maintained across the ultracapacitor. When a potential, ΔV, is applied across the electrodes 20, one electrode becomes positively charged and the other becomes negatively charged. Negatively charged ions in the electrolyte 30 cover the surfaces of the positively charged electrode, while positively charged ions in the electrolyte 30 cover the surfaces of the negatively charged electrode, a result of the aforementioned electrostatic interactions. FIG. 1 illustrates the ultracapacitor with the opposing charges creating the double layer. It is often said that the ions “line up” on the respective electrodes.

Ultracapacitors of the current disclosure may have short charging and discharging cycles, for example of one second or less. They may have a high energy density, for example, at least 10 Wh/kg, or 15 Wh/kg. Some ultracapacitors may have an energy density of over 20 Wh/kg, over 25 Wh/kg, over 33 Wh/kg, or even over 35 Wh/kg or higher. Most ultracapacitors of the current disclosure will have an energy density above 10 Wh/kg. Ultracapacitors of the current disclosure may retain traditional advantage of ultracapacitors, such as high power density. For example, in some embodiments ultracapacitors of the current disclosure may have a power density of 5000 W/kg, 10,000 W/kg, or higher, or between 500 W/kg and 10,000 W/kg. In all of the above measurements, the mass for power density may be either the mass of the carbon electrode(s), or the mass of the ultracapacitor as a whole.

The specific capacitance of ultracapacitors of the current disclosure may be as high as 120 F/g electrode mass, 125 F/g, or even 160 F/g electrode mass.

In other embodiments, ultracapacitors of the current disclosure may be able to sustain high numbers of charge and discharge cycles, such as up to 200,000, 500,000 or 1 million such cycles, or between 200,000 and 1 million cycles or between 500,000 and 1 million cycles. Use of pure graphene or ionic liquid materials may increase the number of cycles and thus ultracapacitor lifetime and may have the added benefit of decreasing assembly costs. According to more embodiments, the ultracapacitors may be low equivalent series resistance. This low equivalent series resistance may allow the ultracapacitors to provide cycling efficiencies of 95% or greater. Ultracapacitor voltage in some embodiments may be at least between 2 V and 6 V, more particularly between 3V and 4 V. Finally, the charge and discharge times for ultracapacitors according to certain embodiments may be on the order of seconds or less.

In other embodiments, ultracapacitors of the current disclosure may function over a wide variety of temperatures. For example, ultracapacitors may function at temperatures as low as −20° C. or even −50° C. or at temperatures as high as 45° C., 50° C., 65° C., or even 300° C. or within ranges between these endpoints. The use of ionic liquids in ultracapacitors may facilitate their ability to function at high temperatures.

In one example, an ultracapacitor with chemically modified graphene electrodes and an electrolyte made of a 1:1 mixture of pyrrolidinium triflates and acetonitrile has an overall specific capacitance of 130 F/g.

In general, energy density of ultracapacitors may vary with the specific capacitance of the electrode material in a linear fashion. Cell voltage may relate to energy density, with the energy density proportional to the square of the cell voltage.

Ultracapacitors of the current disclosure may be thin. The size (e.g. the mass or quantity of materials) of the ultracapacitor may be larger for large ions and smaller for smaller ions. In some embodiments, the electrode thickness may be between 10 μm and 500 μm. Additional materials, such as a collector or separator in an electrode stack may increase the thickness may add an additional 50 μm to 100 μm. In some embodiments, a complete stack of ultracapacitors may be between 200 μm and 800 μm.

### Electrodes

At least one of electrodes 20 may be made of any graphene-based material compatible combatable with electrolyte 30. The other electrode 20 may be made of any other material, including a graphene-based material, compatible with electrolyte 30. Electrodes 20 may be optimized to provide large surface area and compact or small charge separation to improve the energy density of the ultracapacitor. According to one embodiment, one of electrodes 20 may not be graphene-based and may include another carbon electrode material. For example, currently used materials include those such as activated carbon, which facilitates rapid diffusion of ions during charging and discharging cycles. Other non-graphene based materials that may be used in one or more of electrodes 20 include activated carbon, Li-ion, graphite, Pb—C, and combinations thereof. In some embodiments, one or more of electrodes 20 may consist essentially of graphene.

Activated carbon, however, has a restricted surface area that is accessible by the ions in the electrolyte and thus a limited energy density. Accordingly, in specific embodiments of the current disclosure, the both electrodes may include graphene. In some embodiments one or both electrodes may be substantially made of graphene. In other embodiments, the graphene may be used in conjunction with another material to provide mechanical stability or other properties. Materials used in the electrode in conjunction with graphene may be conductive or non-conductive.

Graphene, as the term is used herein, may include graphene as defined by the International Union of Pure and Applied Chemistry (IUPAC)(“IUPAC graphene”), derivatives of such a material, and chemically modified version of such a material, such as chemically activated microwave expanded graphite oxide (MEGO). It also includes any other materials described as graphene herein.

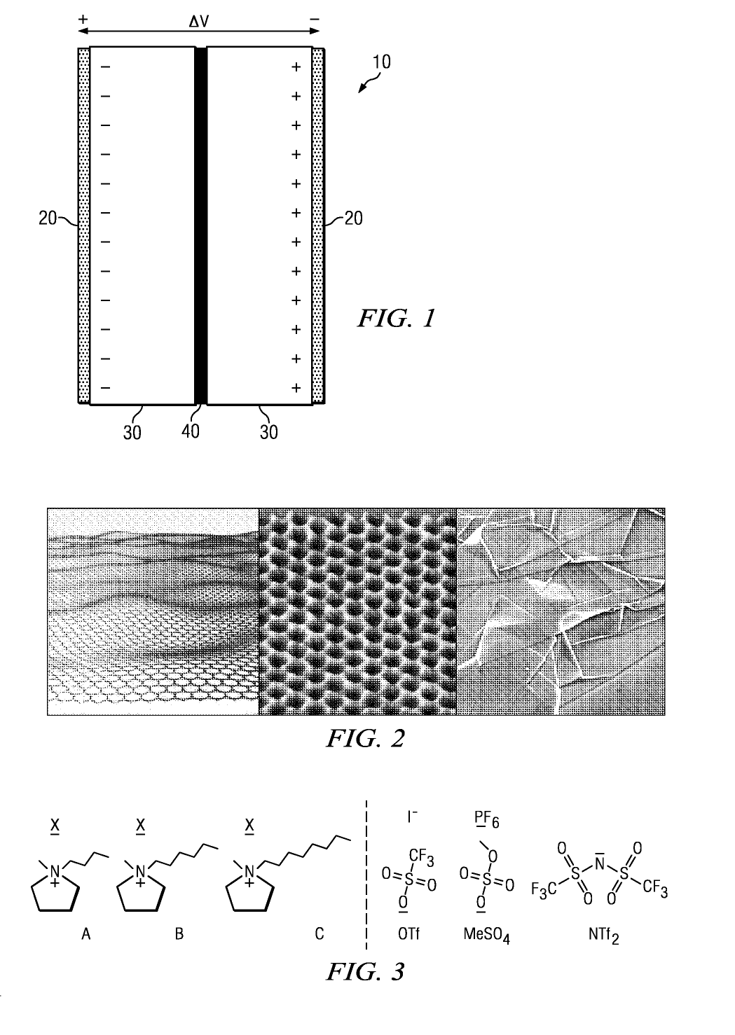

Graphene has a high surface area compared to activated carbon or other nano-scale carbon materials, such as carbon nanotubes. (Although carbon nanotubes are essentially rolled graphene, such ‘rolling’ reduces their available surface area by approximately one half, or more) Graphene, as defined by IUPAC, is an atom-thick structure of bonded carbon atoms densely packed into a honeycomb crystal lattice, for example as shown in FIG. 2. Graphene is semi-metallic and highly conductive. As used in some embodiments, it may be dispersed as single to few-layer-thick sheets providing large surface areas. For example, the graphene surface area of certain electrodes may be from 350 m²/g to as high as 2000 m²/g, or higher. For example, graphene affords the possibility of achieving a very high surface area of contact with the electrolyte to enhance the ultracapacitor performance. The theoretical surface area of a single graphene platelet is about 2630 m²/g. Graphene may also have a high specific capacitance, allowing ultracapacitors employing it with an electrolyte such as an ionic liquid to achieve a high energy density. For example, graphene-based ultracapacitors may have specific capacitances as high as 200 farads/g in aqueous KOH and 150 farads/g in organic electrolytes, including ionic liquid electrolytes. Some ultracapacitors may have specific capacitances as high as 300 F/g in aqueous KOH or 200 F/g in organic electrolytes, including ionic liquid electrolytes. In more particular embodiments, ultracapacitors may have specific capacitances as high as 500 F/g in aqueous KOH or 400 F/g in organic electrolytes, including ionic liquid electrolytes. The highly symmetrical nature of graphene may also cause differences in charging as compared to other carbon electrodes. The differences may be favorably exploited in graphene-based ultracapacitors.

According to a particular embodiment, electrodes 20 may be made of chemically-modified graphene or a graphene that has been expanded by exposure to microwave radiation followed by chemical activation as described herein. Chemically-modified graphene may demonstrate one or more of the following improvements as compared to activated carbon electrodes: ability to be synthesized with different methods into various morphologies and chemical functionalities, very high surface area to allow large potential gains and high energy density, compatibility with high voltage electrolytes, suitable conductivity without additives, low equivalent series resistance in ultracapacitors allowing improved energy efficiency and less resistive heating during high current loads, improved resistance to deleterious effects of water, and elimination of water and hydrolysis products.

According to certain embodiments, the electrodes 20 may include a carbon composition as described in U.S. Provisional Patent Application 61/144,898, PCT/US2009/041768, U.S. patent application Ser. No. 12/430,240, U.S. patent application Ser. No. 11/976,574, PCT/US2004/032585, or U.S. patent application Ser. No. 10/574,507, each of which is incorporated in material part by reference herein.

Graphene may be made using any methods, including those described in the incorporated by reference documents above. Specific methods for obtaining chemically-modified graphene are also disclosed in Park and Ruoff, “Chemical methods for the production of graphenes,” Nat. Nanotechnol:29 (March, 2009), incorporated in material part by reference herein. In particular embodiments, graphene may be produced by reducing graphene oxide with a reducing agent. Example reducing agents include anhydrous hydrazine, hydrazine monohydrate, dimethyl hydrazine, sodium borohydride, hydroquinone, alkaline solutions, and alcohols. Hydrogenation/hydrogen transfer techniques employing small molecule reduced species as hydrogen sources and graphene oxide as the hydrogen sink may also be used. Potential hydrogen sources include 1,2,3,4-tatrahydronapthelene (tetralin), 1,2-dihydronapthelene, 1,4-dihydronapthelene, isopropano and diimide. Catalysts, such as tris(tripenylphosphine)rhodium chloride may also be used as activators of hydrogen that is produced during oxidation of the hydrogen source.

According to a particular embodiment, electrodes 20 may be made of a graphene that is produced by expanding a graphite-oxide derived carbon by exposure to microwave radiation and subsequently chemically activating the carbon to further reduce it, for example using 1-10 Molar KOH between 200-1000° C. for several hours. Such an electrode may be used in conjunction with electrolytes containing propylene-carbonate or acetonitrile or ionic-liquids discussed later or a combination thereof. This type of electrode may be referred to as a chemically activated microwave expanded graphite oxide (MEGO) electrode.

Chemically modified graphene (as opposed to graphene that is solely physically or thermally modified) may also be produced using other methods. For example, zinc chloride, aluminium chloride, magnesium chloride, boric acid, nitric acid, phosphoric acid, potassium hydroxide, sodium hydroxide, combinations thereof, and the like may be used for chemical activation. Example activation processes using some of the reagents are provided in Molina-Sabio, M. and F. Rodríguez-Reinoso, Colloids and Surfaces A: Physicochemical and Engineering Aspects, 241(1-3):15-25 (2004) and Marsh, H. and F. Rodríguez-Reinoso, Activation Processes (Chemical), in Activated Carbon. Elsevier Science Ltd: Oxford. p. 322-365 (2006), both of which are incorporated in material part by reference herein.

In one particular zinc chloride activation process, carbon precursor may be impregnated with zinc chloride, followed by heat treatment underan N₂ flow at 500° C. Such a process is described in Caturla, F., et al., Carbon, 29(7): 999-1007 (1991) and Hu, Z., et al., Carbon, 39(6):877-886 (2001), both incorporated in material part by reference herein.

When phosphoric acid is used for activation, the acid reacts with the carbon source at temperature less than 450° C., leading to what has described as C—C bond weakening and formation of a cross-linked structure. This likely reduces the release of volatile materials, lowers the activation temperature, and increases the carbon yield as described by the following equation:

5C(s)+2P₂O₅(1)→P₄(g)+5CO₂(g).

Examples of such a process are described in Olivares-Marín, M., et al., Carbon, 44(11): 347-2350 (2006) and Molina-Sabio, et al., Carbon, 41(11): 2113-2119 (2003), both incorporated in material part by reference herein.

In still other embodiments potassium hydroxide may be used to activate carbon derived from biological sources, where it may be more effective than sodium hydroxide in terms of high surface area and uniform pore size distribution. The reaction mechanism in the activation with potassium hydroxide is likely as follows:

6KOH+C [symbol] 2K+3H₂+2K₂CO₃.

An example of such a process is described in Lillo-Ródenas, et al., Carbon, 41(2): 267-275 (2003).

Graphene and derivatives of graphene, including chemically modified graphene, may also be subject to agglomeration as they are reduced from a suspension to a solid electrode due to van der Waals forces and other forces. Agglomeration may, in turn, reduce the available surface area of the electrode and thus reduce energy density of any ultracapacitor using the electrode.

In still another embodiment, molecules may be used to space apart graphene sheets in electrodes. The distances of this spacing may be chosen to favor interaction of the electrolyte while providing suitable electrical continuity and conductivity throughout the overall graphene network. In one example, a triptycene molecule, which looks like a tripod, may be used. Other suitable molecules may include benzobarrelene, 1,3,5-tri-tert-butylbenzene, and triphenylmethane, as well as derivates of these molecules. If polymers, such as polystyrene or poly(propylene carbonate) are used to space graphene sheets, they may later be removed to increase overall surface area of the graphene electrode.

According to certain embodiments, a polytetrafluoroethylene (PTFE) binder may be used to form graphene electrodes. For example 5 wt % of this binder may be added to the graphene. Graphene electrodes may be made using any technique, including rolling or molding a graphene-containing paste.

### Ionic Liquid

Ionic liquids are typically salts that melt at temperatures below 100° C. They are typically composed of discrete ions or loosely associated ions, each of which offers a unique set of materials properties. These properties may be unavailable from neutral organic compounds, crystalline inorganic salts, or common solvents, such as water. Ionic liquids may exhibit suitable aspects of one or more of the following properties: high conductivity, high chemical stability, high thermal stability, or high electrochemical stability, large electrochemical window, low melting point, low viscosity, low vapor pressure and volatility, high environmental stability, low toxicity, low cost, ease of scalability and purification. According to specific embodiments, the ionic liquid may be operable at high potential, such as 2.0 V or higher.

The melting point of ionic liquids may be decreased by using liquids with lower anion/cation interactions or with more diffuse charge structures. Melting points may also be decreased by using asymmetric ionic liquids as well as by introducing various types of synthetic oligomers or polymers as pendant functionalities.

The viscosity of ionic liquids may be decreased by the presence of perfluorinated anions and oligomer or polymer substituents. Linked moieties possessing multiple charged components may also lower viscosity while simultaneously increasing thermal stability.

The electrochemical window of ionic liquids may be broadened by adding fluorinated alkyl chains to the cation. This may cause dramatic differences in the local electronic environments. The anions may be fluorinated anions, such as bistriflimide, or a dicyanamide anion.

Thermal stability may be increased in ionic liquids by linking multiple charged groups together or through the use of fluorinated components, as described above. Reactivity as a function of temperature may also be used to select ionic liquids more thermally stable at ultracapacitor operation or storage temperatures.

According to a specific embodiment of the current disclosure, any suitable ionic liquid-based electrolyte 30 may be used in conjunction with electrodes 20. These may include ionic liquids with both ammonium and imidazolium cations. In particular embodiments, these cations may be paired with tetrafluoroborate or bis(trifluoromethanesulfonyl)imide anions.

According to another specific embodiment, the ionic liquid 30 may include a cyclic ammonium- or phosphonium-based composition and the electrodes 20 may be made of any suitable material. According to a more specific embodiment, the ionic liquid may include a spirocyclic ammonium- or phosphonium-based composition. According to more specific embodiments, it may be certain compositions shown in FIG. 3. FIG. 3 also discloses N-methyl-N-alkyl pyrrolidinium bistriflimide from the prior art as a comparative example.

In specific embodiments using pyrrolidinium salts as cations, the inclusion of a longer alkyl chain may decrease the melting point of the ionic liquid, leading to other beneficial effects. For example, an octyl-functionalized cation may have a melting point of −15.2° C. A cation/anion combination with a desired melting point may be selected using the information provided in Appetecchi, Giovanni, et al., Electrochimica Acta 54:1325-1332 (2009), incorporated in material part by reference herein. In certain embodiments, the ionic liquid may be pyrrolidinium-based ionic liquids having a melting point lower than −10° C., non-pyrrolidinium-based cyclic ammoniums, phosphonium-based cyclic ammoniums. In specific embodiments, the ionic liquid may use an N-methyl-N-alkyl pyrrolidinium bistriflimide ionic liquid having a melting point of −10° C. or lower. In other embodiments, the ionic liquid may be a spirocyclic ammonium- or phosphonium -based ionic liquid. In still other embodiments, the ionic liquid, an acyclic ammonium- or phosphonium-based ionic liquid. In further embodiments, the ionic liquid may be combinations of one or more ionic liquids otherwise discussed herein.

One specific ammonium-based ionic liquid that may be used includes N,N-diethyl-N-methyl-N-(2-methoxyethyl)ammonium bis(trifluoromethanesulfonyl) amide. This composition is non-flammable, operates in a wide potential window (5.4 V) and has a high ionic conductivity (4.0 mS/cm at 30° C.).

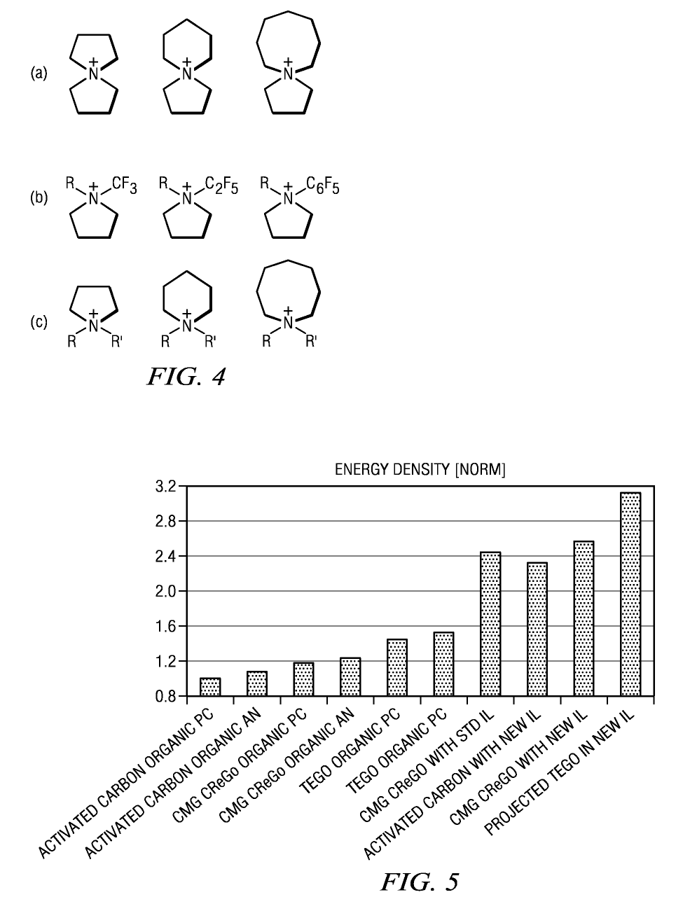

Other potential ionic liquids are described in FIG. 4. FIG. 4, row (a) shows a series of cyclic ammonium salts. These salts combine the high electrochemical stability of quaternary ammonium salts, such as pyrrolidinium salts, with increased shielding of the charged center. This shielding may help decrease cation-anion coordination, decreasing the melting point of the ionic liquid. Asymmetry in the ring size may also decrease crystallinity caused by ordered hydrophobic interactions between the aliphatic molecules. FIG. 4, row (b) shows compounds in which fluorinated aklylating agents are used to cause dramatic differences in the local electronic environments of the fluoroalkyl substituents, the N-heterocycle, and the anion. FIG. 4, row (c) shows additional cyclic ammonium salts that may be used as the basis for an ionic liquid with a lower melting point. Other cyclic ammoniums salts with sufficient bulk and hydrophobicity to decrease interactions with the triflate anion may also be used to decrease crystallization of the ionic liquid.

According to a specific embodiment, the ionic liquid may include between 1 to 99 wt % ionic liquid and 1 to 99 wt % solvent. Suitable solvents include, but are not limited to acetonitrile, benzonitrile, other low boiling nitriles, propylene carbonate, ethylene carbonate, dimethyl carbonate, similar solvents, and mixtures thereof.

Tests of various ionic liquids have revealed the properties in Table 1.

TABLE 1
Ionic Liquid Properties

| Ionic Liquid | T_{g} or Tₘ (° C.) | T_{d} (° C.) | EW (V) |
|---|---|---|---|
| FIG. 3A; X = I | 8.62 | 254.11 | 2.6774 |
| FIG. 3B; X = I | 18.38 | 246.11 | 2.7233 |
| FIG. 3C; X = I | 28.93 | 229.73 | 2.8988 |
| FIG. 3A; X = MeSO₄ | −42.58 | 296.74 | 3.8649 |
| FIG. 3B; X = MeSO₄ | −58.19 | 287.12 | 2.1535 |
| FIG. 3C; X = MeSO₄ | −71.79 | 265.34 | 2.1308 |
| FIG. 3A; X = OTf | 22.31 | 255.14 | 4.6672 |
| FIG. 3B; X = OTf | 14.58 | 267.10 | 4.5100 |
| FIG. 3C; X = OTf | 17.17 | 355.95 | 4.1664 |
| FIG. 3A; X = NTf₂ | −16.47 (T_{g}) | 248.47 | 3.5355 |
| (comparative example) | −6.3 (Tₘ) | | |
| FIG. 3B; X = NTf₂ | −28.12 | 231.90 | 3.4040 |
| FIG. 3C; X = NTf₂ | −42.13 | 235.47 | 3.3325 |
| FIG. 3A; X = PF₆ | 26.21 | 300/51 | 4.5453 |
| FIG. 3C; X = PF₆ | 18.47 | 314.38 | 4.8330 |

In Table 1, T_{g} represents the glass transition temperature, Tₘ represents the melting point, T_{d} represents the decomposition temperature, and EW represents the electrochemical window.

As the data in Table 1 shows, ammonium-based ionic liquids may exhibit high resistance to thermal decomposition. Such ionic liquids may also exhibit reduced reactivity with other chemicals and thus improved stability when no functional group is present.

Although single ionic liquids are analyzed above, one of ordinary skill in the art may combine two or more ionic liquids for example to draw upon the desirable properties of each. Such ionic liquid combinations may be analyzed in the same manner as single ionic liquids or they may be subject to different types of analysis more applicable to mixtures. For example, mixtures may be subjected to rheometric analysis to determine which combinations lead to low viscosity and high complex conductivities. In some embodiments, an additional ionic liquid having less desirable other properties, but a desirable viscosity or melting point, may be added to a primary ionic liquid to obtain the electrolyte 30 with a suitable viscosity or melting point.

Viscosities of mixtures of two ionic liquids will likely follow the following equation (1), where η₁ and η₂ are the viscosities of ionic liquids 1 and 2, N₁ and N₂ are their molar fractions, and x₁ and x₂ are their free volumes:

η=η₁N₁(x₁/x)+η₂N₂(x₂/x) (1).

The volume, x of such a mixture may be given by the following equation where V₁ and V₂ are the volume fractions of component liquids 1 and 2:

x=x₁V₁+x₂V₂ (2).

In other embodiments, mixtures of ionic liquids may utilize the unique solvent properties of ionic liquids for dissolution of neutral additives. In still other embodiments, non-stoichiometric mixtures of ionic liquids may be prepared with there acid or base ion precursors. Both approaches may increase the fluidity of the ionic liquid or may decrease the viscosity while maintaining low vapor pressure.

According to some embodiments, the electrolyte 30 may include the ionic liquid and another, non-ionic liquid, such as an exogenous solvent. The other liquid may be present in various amounts and may help render the viscosity or melting point of the electrolyte as a whole suitable for a particular ultracapacitor. For example, 10 wt % acetonitrile may be present in the electrolyte 30 when a triflate ionic liquid is used. Triflate containing ionic liquids tend to be tacky solids at room temperature. Although the acetonitrile has a generally deleterious effect of dilution of the ionic liquid, it greatly decreases the viscosity and melting point of the mixture as compared to ionic liquid alone. In some embodiments, the melting point of the mixture is decreased to nearly that of the solvent alone (−45° C.). Decreased melting point and increased viscosity of electrolyte 30 may improve the ultracapacitor as a whole because it may provide greater ion mobility, allowing faster and more efficient charging and discharging. For example, the relationship of the electrolyte viscosity and conductivity may be governed by the Walden relationship, Λη₁=constant, where Λ is the equivalent conductivity (in S·cm² mol⁻¹) and η is the viscosity of the ionic liquid.

In still other embodiments, the ionic liquid may be anhydrous before it is assembled into the ultracapacitor, after it is assembled into the ultracapacitor or both. In embodiments where the ionic liquid is anhydrous after assembly into the ultracapacitor, the residual water content of the graphene used in the electrodes may be sufficiently low to preserve the anhydrous state of the ionic liquid. In particular embodiments, the anhydrous ionic liquid may have a water content of less than 10 ppm. In other embodiments, the anhydrous liquid may have sufficiently low water to avoid detectable hydrolysis products in the ultracapacitor during the life of the ultracapacitor (as defined by factors other than degradation due to hydrolysis).

In some embodiments, the addition of a second, or more, additional liquids to the ionic liquid may not be needed because the ionic liquid may have a suitable viscosity or melting point for the ultracapacitor operation temperature. Such ionic liquids may avoid deleterious effects associated with dilution. In other embodiments, the dilution may be 10 wt % or less.

### Synthesis of Ionic Liquids

Embodiments of the current disclosure also relate to methods of synthesizing ionic liquids. In certain embodiments, synthesis methods may focus on one or more of the following criteria:

solventless reaction conditions

simple protocols

limited number of synthetic steps

limited or no byproducts and ease of byproduct removal

heat transfer control

security and safety for transportation, storage, and processing.

Some synthetic methods may use pure stoichiometric salts produced by metathesis in a suitable solvent, via solvent-free technologies, or by microwave-assisted reactions. Other specific synthetic methods may also be used, including those described in the examples below.

### Uses of Ultracapacitors

Ultracapacitors of the current disclosure may be used for a variety of applications. The size of ultracapacitors may be readily scalable depending on the intended use.

Ultracapacitors of the current disclosure may be used in combination with other electrical energy storage devices, such as other capacitors, ultracapacitors, or batteries. For example, an ultracapacitor may be hybridized with a battery to provide a long-lasting battery. Such hybridized batteries may be particularly useful in automotive applications.

In specific embodiments, ultracapacitors of the current disclosure may be used in regenerative storage applications. Regenerative storage includes technologies that can store energy during regenerative braking. Currently, automobiles, trains, and buses primarily use friction-based braking, which all energy is lost as heat. In order to work efficiently to store energy instead of losing it, batteries or other energy storage devices need to store and release charge quickly, often in the matter of seconds. Current batteries lack this capability. Ultracapacitors of the current disclosure may be able to meet these time demands in automobiles and other vehicles. Further, ultracapacitors of the current disclosure may offer other advantages, such as the ability to last for the life of the vehicle or an appropriately light weight. Ultracapacitors designed for use in vehicles may have any of a variety of shapes, including non-traditional shapes, allowing them to be better conformed to available vehicle cavities.

Ultracapacitors of the current disclosure may also be used in distributed storage applications, such as power grids, which often need to store extra energy generated during peak generating conditions, such as peak wind or solar hours, then provide that energy at other times for use. Ultracapacitors of the current disclosure may be able to be integrated into an electrical grid to allow for fast storage and retrieval of electrical energy. For example, ultracapacitors of the current disclosure may be used to stabilize a power grid. Ultracapacitors used in these fashions may also have long life. In particular embodiments, ultracapacitors of the disclosure may be used in conjunction with a traditional coal or petrochemical-based generation system, a wind generation system, or a solar generation system.

Ultracapacitors of the current disclosure may also be used in applications that utilize pulsing power. Such applications include hand-held devices such as flash cameras, power data transactions, mechanical de-icing, rechargeable power tools and the like.

Ultracapacitors may also be used in applications where long-term energy storage is desirable, such as in backup power supplies for various systems.

Ultracapacitors of the current disclosure may reduce waste overall if used in the place of batteries or as partial replacements for batteries due to the longer life of ultracapacitors.

Ultracapacitors of the current disclosure may be used in high temperature applications, particularly applications where the temperature may reach above 65° C. For example, ultracapacitors may be used in downhole tools such as earth boring drill bits or downhole sensors in the petrochemical and mining industries.

Ultracapacitors of the current disclosure may also be used in underwater applications.

In ultracapacitors containing graphene and an anhydrous ionic liquid, the deleterious effects that residual water has in current ultracapacitors that use activated carbon may be avoided. In particular, by eliminating the need to use water, some ultracapacitors of the disclosure may have a unique advantage of eliminating its hydrolysis products, hydrogen and oxygen, two deleterious species that ultimately lead to the failure of conventional ultracapacitor cells.

According to a particular embodiment, the ultracapacitor may be located in an electrochemical energy storage device. In specific embodiments, the storage device may be located in a structure to which the storage device supplies power. For example, it may be located in an automobile, an electrical grid, or a power tool or hand held object. The storage device may include other components to allow the ultracapacitor to provide power or to otherwise assist in its function either directly or by providing structural support or protection. For example, the storage device may include a standalone or embedded storage unit in which the capacitor is housed.

### Methods of Using Ultracapacitors

The current disclosure also provides methods of using any of the above ultracapacitors to store energy. In such methods, in general, the ultracapacitor may be coupled to an energy source, then charged. The ultracapacitor may then be coupled to a power consuming device or system and discharged. The properties for charge and discharge may be those described for ultracapacitors above. The charge and discharge cycles may be repeated. According to particular embodiments, they may be repeated at least 200,000, at least 500,000, or at least 1 million times.

According to other particular embodiments, the ultracapacitors may be used for the particular uses described above. For example, the ultracapacitors may be charged by an energy production source, such as a power plant, then discharged into an electrical grid system when energy is needed by the system.

### Methods of Making Ultracapacitors

The disclosure also provides methods of making ultracapacitors of the types described above. In general, such ultracapacitors may be made by placing an electrolyte including an ionic liquid in electrical contact with two electrodes, at least one of which contains graphene, and a non-conductive or dielectric separator to form a cell able to function as an ultracapacitor.

According to more specific embodiments, residual water may be removed from any graphene-containing electrodes prior to assembly of the cell.

According to other embodiments, the ionic liquid may first be formed according to any methods described herein or otherwise known in the art.

### EXAMPLES

The present disclosure may be better understood through reference to the following examples. These examples are included to describe exemplary embodiments only and should not be interpreted to encompass the entire breadth of the invention.

### Example 1

### Capacitor Testing

A variety of capacitors of the general structure shown in FIG. 1 and with various electrode materials and various aqueous, organic, and ionic liquid electrolytes were constructed and tested for energy density. Results of these tests are shown in FIG. 5, which shows the energy density of various electrode and electrolyte combinations. As the figures show, graphene-electrodes are expected to demonstrate higher energy density, which will increase with the addition of ionic liquids.

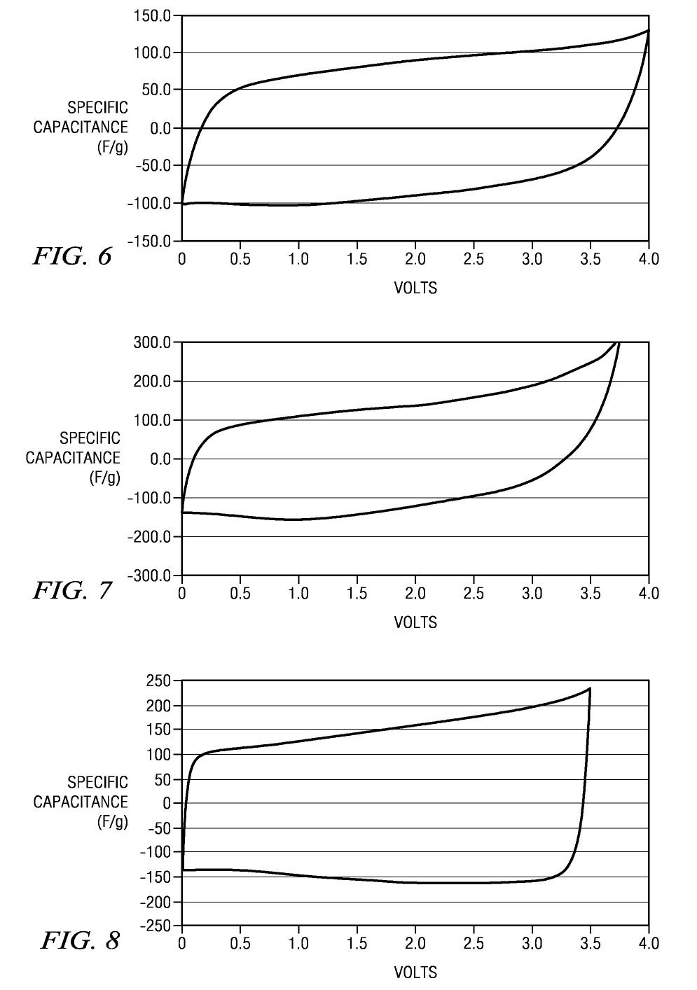

Ultracapacitors containing ionic liquids have been demonstrated to have suitable operating windows. FIG. 6 shows the results of cyclic voltammogram tests using the ionic liquid N-methyl-N-octyl pyrrolidinium triflate in acetonitrile (1:1) as the electrolyte in an activated commercial carbon electrode ultracapacitor. The operating window was about 4.0 V. FIG. 7 presents similar data showing as suitable operating window for the same ionic liquid in an ultracapacitor with graphene electrodes.

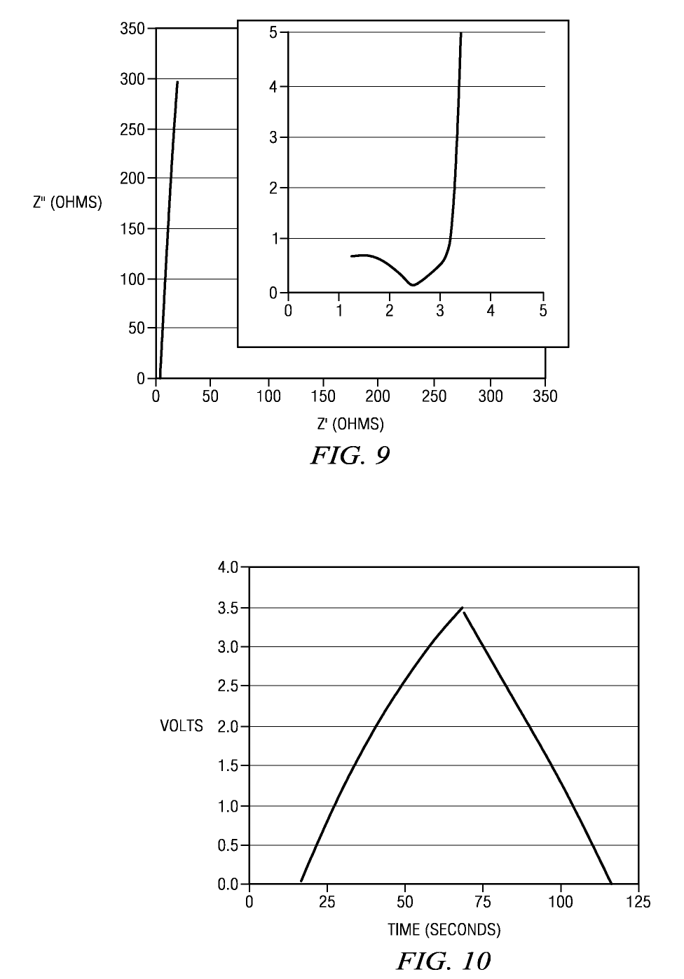

FIG. 8 illustrates a cyclic voltammogram showing BMIMBF4 ionic liquid in acetonitrile (1:1 w/w) in an activated MEGO electrode. The scan rate was 100 mV/sec. FIG. 9 illustrates a Nyquist plot showing BMIMBF4 ionic liquid in acetonitrile (1:1 w/w) with an activated MEGO electrode. The calculated RC time constant is 0.5 seconds.

FIG. 10 illustrates a constant current charge discharge plot showing BMIMBF4 ionic liquid in acetonitrile (1:1 w/w) with an activated MEGO electrode. The discharge current was 10 mA (2830 mA/g current density) and the specific capacitance during discharge from Vmax to ½ Vmax (3.5V to 1.75V) was 166 F/g.

Further ultracapacitors containing ionic liquids have been demonstrated to have a suitable specific capacitance. Table 2 shows the specific capacitance performance for three electrode materials using N-methyl-N-octyl pyrrolidinium triflate ionic liquid in acetonitrile electrolyte (1:1).

TABLE 2
Specific Capacitance of Electrode Materials in Ionic Liquid

| | Galvanostatic discharge (F/g) | | | |
|---|---|---|---|---|
| | 2 mA | 5 mA | 10 mA | 20 mA |
| Commercial Activated Carbon with | 107 | 108 | 97 | 93 |
| Ionic Liquid Electrolyte | | | | |
| CReGO Graphene with Ionic Liquid | 93 | 123 | 107 | 75 |
| Electrolyte | | | | |
| Activated MEGO Graphene with Ionic | — | 165 | 166 | 166 |
| Liquid Electrolyte | | | | |

### Example 2

### Synthesis of Ionic Liquids

Ionic liquids according to embodiments of the current disclosure may be synthesized according to the guidelines below. All reactions are performed using reagents that have been distilled over 3A molecular sieves (Delta Adsorbents) under nitrogen, or recrystallized if they are solids. All solvents are purified using a solvent purification system and are maintained under air- and water-free conditions.

Symmetrically-Substituted Cyclic Ammonium Ionic Liquids (including pyrrolidinium and piperidinium ILs): One equivalent of the amine (piperidine or pyrrolidine) is dissolved in methylene chloride. One equivalent of a weak base (e.g., sodium bicarbonate) is stirred heterogeneously with the dissolved amine to create a slightly basic environment. 2.1 equivalents of the alkylating agent (e.g., bromooctane) are added slowly (if the reaction is exothermic, the addition is performed on an ice bath to prevent boiling of the solvent during addition). The mixture is then heated to a moderate temperature (40-60° C.) for 10-14 hours. The salt byproduct that forms (e.g., sodium bromide) is filtered away and the IL dissolved in the filtrate is recovered by evacuation of the solvent. Unreacted starting materials are removed by trituration in diethyl ether or hexanes.

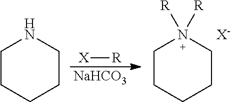

Asymmetrically-Substituted Cyclic Ammonium Ionic Liquids: One equivalent of a monosubstited amine (e.g., N-methylpiperidine, purchased commercially or prepared according to literature procedures) is dissolved in methylene chloride. 1.1 equivalents of an alkylating agent are added (in an ice bath if the reaction is exothermic) and the reaction is stirred at 40-60° C. for 10-14 hours. The solvent is removed under vacuum and the material is purified by triturating unreacted materials in diethyl ether or hexanes.

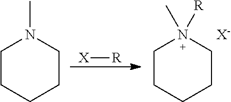

Spirocyclic Ammonium Ionic Liquids: One equivalent of an amine (e.g., piperidine) is dissolved in methylene chloride. One equivalent of a weak base is added and the mixture is stirred. 1.0 equivalent of a α,ω-dihaloalkane (e.g., 1,4-dibromobutane) is added slowly and the solution is brought to 40-60° C. for 10-14 hours. The salt precipitate is removed by filtration and the solvent is removed by evacuation. The crude solid is purified by trituration with diethyl ether or hexanes and recrystallization from ethanol, followed by filtration and collection of the solid.

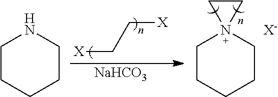

Anion Metathesis: All of the above mentioned ionic liquids contain halide counterions (typically bromide or chloride). Conversion to any of several other ion pairs is performed as follows:
Tetrafluoroborate—The halide IL is dissolved in methylene chloride or acetonitrile and 1.0 equivalent of silver(I) tetrafluoroborate or sodium tetrafluoroborate is heterogeneously stirred with the solution. A gray precipitate forms. After complete precipitation (typically 4-6 hours), the solid is separated from the supernatant by filtration and the solvent is removed by evacuation.
   Alternatively, the halide IL may be mixed with 1.0 equivalent of triethyloxonium tetrafluoroborate (ethyl Meerwein's reagent). This reaction affords the release of one equivalent of ethyl halide (e.g., ethyl bromide), one equivalent of diethyl ether, and one equivalent of the tetrafluorborate IL.
Hexafluorophosphate—Identical procedure to that given for tetrafluoroborate, except that silver(I) hexafluorophosphate or sodium hexafluorophosphate are used in place of the tetrafluoroborate sources.
Methyl sulfate—The IL is dissolved in methylene chloride and 1.1 equivalent of dimethyl sulfate is added (on an ice bath if the reaction is exothermic). One equivalent of methyl halide (e.g., methylbromide) is lost as vapor, and the methyl sulfate IL is left in solution.
Bis(trifluoromethanesulfonyl)imide (i.e., bistriflimide)—The halide ionic liquid is dissolved in methylene chloride. To this solution 1.0 equivalent of lithium bistriflimide is added and the reaction is stirred for 6-8 hours at room temperature. The solvent is removed under evacuation and the lithium halide that forms as a byproduct is removed by trituration with acetone.
   Alternatively, the halide IL may be dissolved in water and 1.0 equivalent of lithium bistriflimide is added and the reaction is stirred for 8-10 hours at room temperature. The bistriflimide IL phase separates from the aqueous solution and is collected by decanting the supernatant.
Trifluoromethanesulfonate (i.e., triflate)—The halide IL is dissolved in methylene chloride or acetonitrile. 1.1 equivalents of methyl triflate is added at room temperature. Gaseous methyl halide (e.g., methylbromide) is released, requiring virtually no purification of the product, although unreacted methyl triflate is removed by trituration with diethyl ether or hexanes.
   Alternatively, silver(I) triflate and sodium triflate may be used in a manner identical to that described above for the tetrafluoroborates.

Although only exemplary embodiments of the invention are specifically described above, it will be appreciated that modifications and variations of these examples are possible without departing from the spirit and intended scope of the invention. For example, throughout the specification particular measurements are given. It would be understood by one of ordinary skill in the art that in many instances other values similar to, but not exactly the same as the given measurements may be equivalent and may also be encompassed by the present invention. Unless clearly exclusive by context, the term “or” as used herein shall mean both one or the other and both one and the other.

1. A electrochemical energy storage device comprising an ultracapacitor comprising:
at least one electrode comprising graphene;
an electrolyte comprising an ionic liquid selected from the group consisting of:
a pyrrolidinium-based ionic liquid having a melting point lower than −10° C., a non-pyrrolidinium-based cyclic ammonium, a phosphonium-based cyclic ammonium, a spirocyclic ammonium- or phosphonium-based ionic liquid, an acyclic ammonium- or phosphonium-based ionic liquid, and any combinations thereof; and
a dielectric separator dividing the ultracapacitor into two chambers, each chamber containing an electrode and a portion of the electrolyte.

2. The electrochemical energy storage device according to claim 1, wherein the graphene comprises a graphene that has been exposed to microwave radiation then chemically activated.

3. The electrochemical energy storage device according to claim 2, wherein the graphene comprises chemically activated graphene, wherein the graphene has been chemically modified using a reagent selected from the group consisting of: zinc chloride, aluminium chloride, magnesium chloride, boric acid, nitric acid, phosphoric acid, potassium hydroxide, sodium hydroxide, and combinations thereof.

4. The electrochemical energy storage device according to claim 1, wherein the electrode further comprises activated carbon, Li-ion, graphite, Pb—C, or a combination thereof.

5. The electrochemical energy storage device according to claim 1, wherein the electrode consists essentially of graphene.

6. The electrochemical energy storage device according to claim 1, wherein the electrolyte comprises a mixture of 1 to 99 wt % ionic liquid and 1 to 99 wt % solvent.

7. The electrochemical energy storage device according to claim 1, wherein the ultracapacitor is functional at temperatures above 65° C.

8. The electrochemical energy storage device of claim 1, wherein the ultracapacitor is housed in a structure to which the storage device supplies power, wherein the structure is an automobile, an electric grid, a power tool or other hand held object.

9. The electrochemical energy storage device of claim 1, wherein the ultracapacitor has a specific capacitance of at least 120 F/g electrode mass.

10. The electrochemical energy storage device of claim 1, wherein the ultracapacitor has an energy density of at least 33 Wh/kg electrode mass.

11. An ultracapacitor comprising:
at least one electrode comprising graphene comprising microwave expanded graphite oxide (MEGO) that has been chemically activated and further reduced;
an electrolyte comprising an ionic liquid; and
a dielectric separator dividing the ultracapacitor into two chambers, each chamber containing an electrode and a portion of the electrolyte.

12. The electrochemical energy storage device according to claim 11, wherein the ionic liquid is selected from the group consisting of: a pyrrolidinium-based ionic liquid having a melting point lower than −10° C., a non-pyrrolidinium-based cyclic ammonium, a phosphonium-based cyclic ammonium, a spirocyclic ammonium- or phosphonium-based ionic liquid, an acyclic ammonium- or phosphonium-based ionic liquid, and any combinations thereof.

13. The electrochemical energy storage device according to claim 11, wherein the microwave expanded graphene has been chemically activated by further reducing the graphene using a reagent selected from the group consisting of: zinc chloride, aluminium chloride, magnesium chloride, boric acid, nitric acid, phosphoric acid, potassium hydroxide, sodium hydroxide, and combinations thereof.

14. The electrochemical energy storage device according to claim 11, wherein the electrode further comprises activated carbon, Li-ion, graphite, Pb—C, or a combination thereof.

15. The electrochemical energy storage device according to claim 11, wherein the electrolyte comprises a mixture of 1 to 99 wt % ionic liquid and 1 to 99 wt % solvent.

16. The electrochemical energy storage device according to claim 11, wherein the ultracapacitor is functional at temperatures above 65° C.

17. The electrochemical energy storage device of claim 11, wherein the ultracapacitor is housed in a structure to which the storage device supplies power, wherein the structure is an automobile, an electric grid, a power tool or other hand held object.

18. The electrochemical energy storage device of claim 11, wherein the ultracapacitor has a specific capacitance of at least 120 F/g electrode mass.

19. The electrochemical energy storage device of claim 11, wherein the ultracapacitor has an energy density of at least 33 Wh/kg electrode mass.

20. A process of making activated microwave expanded graphite oxide (MEGO) comprising:
expanding and reducing graphite oxide with microwave radiation to produce MEGO; and
chemically activating the MEGO using a reagent selected from the group consisting of: sodium hydroxide, potassium hydroxide, steam, carbon dioxide, zinc chloride, aluminum chloride, magnesium chloride, boric acid, nitric acid, phosphoric acid, and any combinations thereof to produce a chemically activated and further reduced MEGO.
